(19) United States
(12) Patent Application Publication
(10) Pub. No.: US 2024/0290083 A1
(43) Pub. Date: Aug. 29, 2024

(54) PROCESSING METHOD, PROCESSING SYSTEM, AND PROCESSING PROGRAM

(71) Applicant: NIPPON TELEGRAPH AND TELEPHONE CORPORATION, Tokyo (JP)

(72) Inventors: Kyoku SHI, Tokyo (JP); Takeharu EDA, Tokyo (JP); Akira SAKAMOTO, Tokyo (JP); Shohei ENOMOTO, Tokyo (JP); Ichiro MORINAGA, Tokyo (JP)

(73) Assignee: NIPPON TELEGRAPH AND TELEPHONE CORPORATION, Tokyo (JP)

(21) Appl. No.: 18/573,910

(22) PCT Filed: Jun. 24, 2021
(86) PCT No.: PCT/JP2021/024042

§ 371 Date: Dec. 22, 2023

(51) Int. Cl. G06V 10/82; G06T 7/20; G06T 7/70; G06V 20/52

(52) U.S. Cl. CPC G06V 10/82; G06T 7/20; G06T 7/70; G06V 20/52; G06T 2207/30242

(57) ABSTRACT

A processing system (100) is a processing system that executes inference process in an edge device (30) and a server device (20). The edge device (30) includes an inference unit (31) that executes inference related to a first task on inference target data by using a DNN1; and a determination unit (32) that transmits an intermediate output value of the DNN1 used to execute the inference related to the first task to the server device (20) so that the server device (20) executes a second task which is different from the first task and has a higher operation amount than the first task.

### TECHNICAL FIELD

The present invention relates to a processing method, a processing system, and a processing program.

### BACKGROUND ART

In recent years, real-time applications using deep neural networks (DNNs) such as video monitoring, voice assistants, and automatic driving have appeared. Such real-time applications are required to process large amounts of queries in real time with limited resources while maintaining accuracy of the DNNs. Accordingly, a technology called a model cascade that can speed up an inference process with little deterioration in accuracy by using a high-speed lightweight model and a low-speed non-lightweight model has been proposed.

In the model cascade, a plurality of models including a lightweight model and a non-lightweight model are used. When inference is executed by the model cascade, estimation is first executed by the lightweight model. When the result is reliable, the result is adopted and the process is terminated. On the other hand, when the estimation result of the lightweight model is not reliable, inference is continuously executed with the non-lightweight model, and the result is adopted. For example, an IDK (I Don't Know) cascade (see, for example, Non Patent Literature 1) is known in which an IDK classifier is introduced to determine whether an estimation result of a lightweight model is reliable.

### CITATION LIST

### Non Patent Literature

Non Patent Literature 1: Wang, Xin, et al. “IDK Cascades: Fast Deep Learning by Learning not to Overthink.” arXiv preprint arXiv: 1706.00885 (2017).

### SUMMARY OF INVENTION

### Technical Problem

The method described in Non Patent Literature 1 is based on the premise that a lightweight model on an edge side and a non-lightweight model on a cloud side execute learning for the same purpose because inference is not examined and learning is also conceived from fine tuning. However, cases in which different tasks are executed on the edge side and the cloud side have not been examined. When the tasks are separately executed, it is necessary to transmit inference target data to the cloud side. Thus, there is a problem in that use of a transmission path and calculation executed on the edge cannot be utilized.

The present invention has been made in view of the above circumstances and an object of the present invention is to provide a processing method, a processing system, and a processing program capable of implementing utilization of a calculation result executed by an edge device and a reduction in a transmission amount when different tasks are executed by the edge device and the cloud.

### Solution to Problem

In order to solve the above-described problems and achieve the object, a processing method according to the present invention is a processing method of executing an inference process in an edge device and a server device. The method includes: a step of executing, by the edge device, inference related to a first task on inference target data by using a first model; and a step of transmitting, by the edge device, an intermediate output value of the first model used to execute the inference related to the first task to the server device so that the server device executes a second task which is different from the first task and has a higher operation amount than the first task.

A processing system according to the present invention is a processing system executing an inference process in an edge device and a server device. The edge device includes: an inference unit that executes inference related to a first task on inference target data by using a first model; and a transmission unit that transmits an intermediate output value of the first model used to execute inference related to the first task to the server device so that the server device executes a second task which is different from the first task and has a higher operation amount than the first task.

A processing program according to the present invention is a processing program causing a computer serving as an edge device in a processing system to execute a method and causing a computer executing an inference process in an edge device and a server device to execute: a step of executing inference related to a first task on inference target data by using a first model; and a step of transmitting an intermediate output value of the first model used to execute the inference related to the first task to the server device so that the server device executes a second task which is different from the first task and has a higher operation amount than the first task.

### Advantageous Effects of Invention

According to the present invention, when different tasks are executed by an edge device and a cloud, utilization of a calculation result executed by the edge device and a reduction in a transmission amount can be implemented.

### BRIEF DESCRIPTION OF DRAWINGS

FIG. 1 is a diagram illustrating an example of a DNN 1 and a DNN 2.

FIG. 2 is a diagram schematically illustrating an example of a configuration of a processing system according to an embodiment.

FIG. 3 is a diagram illustrating selection examples of base models of the DNN 1 and the DNN 2.

FIG. 4 is a diagram schematically illustrating a structure of YOLOv3.

FIG. 5 is a diagram illustrating an inference route according to the embodiment.

FIG. 6 is a diagram illustrating an exemplary structure of the DNN 1 and the DNN 2.

FIG. 7 is a diagram illustrating an exemplary structure of the DNN 1 and the DNN 2.

FIG. 8 is a diagram illustrating an overview of a process of the processing system.

FIG. 9 is a diagram illustrating an overview of a process of the processing system.

FIG. 10 is a sequence diagram illustrating a flow of a process of the processing system according to the embodiment.

FIG. 11 is a diagram illustrating an example of a computer in which an edge device, a server device, and a setting device are implemented by executing a program.

### DESCRIPTION OF EMBODIMENTS

Hereinafter, an embodiment of the present invention will be described in detail with reference to the drawings. The present invention is not limited to this embodiment. Further, in the description of the drawings, the same portions are denoted by the same reference signs.

### Embodiment

In the embodiment, a processing system that executes an inference process using a learned lightweight model and non-lightweight model will be described. The lightweight model and the non-lightweight model execute inference related to different tasks. In the processing system according to the embodiment, a case where a deep neural network (DNN) is used as a model used in the inference process will be described as an example. Note that any neural network may be used in the processing system of the embodiment. In the processing system according to the embodiment, signal processing with a low operation amount and signal processing with a high operation amount may be used instead of the learned model.

In the processing system according to the embodiment, a lightweight model (for example, a DNN 1 (a first model)) and a non-lightweight model (for example, a DNN 2 (a second model)) are included in a model cascade. The DNN 1 is a high-speed and lightweight model and executes inference related to a first task on inference target data (for example, an image). The DNN 2 is a low-speed non-lightweight model and executes inference related to the second task on inference target data of the DNN 1. The second task is different from the first task and has a higher operation amount than the first task.

As described above, when the process is executed by dividing the tasks between the edge device and the server device, there is a problem in minimization and accuracy of a transmission amount and a total operation amount in the edge device and the server. For example, in general, a feature amount is extracted by the edge device, a process is executed by the edge device using the extracted feature amount, the feature amount is transmitted to the server device, and a process is executed by the server device. However, it is desirable to select an effective feature amount extraction function in accordance with each task as the feature amount. Therefore, when it is attempted to process different tasks using feature amounts extracted using the same feature amount extraction function, it is conceivable that the accuracy of one feature amount is insufficient or the size of the feature amount becomes excessive. Therefore, in this processing system, whether the process is executed in the edge device using the high-speed DNN 1 or the cloud (the server device) using the low-speed DNN 2 is controlled according to a preset rule. Then, when the process is executed in the server device, the edge device transmits an intermediate output value of the DNN 1 to the server device. In the server device, the DNN 2 executes inference related to the second task using the intermediate output value as an input.

### [Lightweight Model and Non-Lightweight Model]

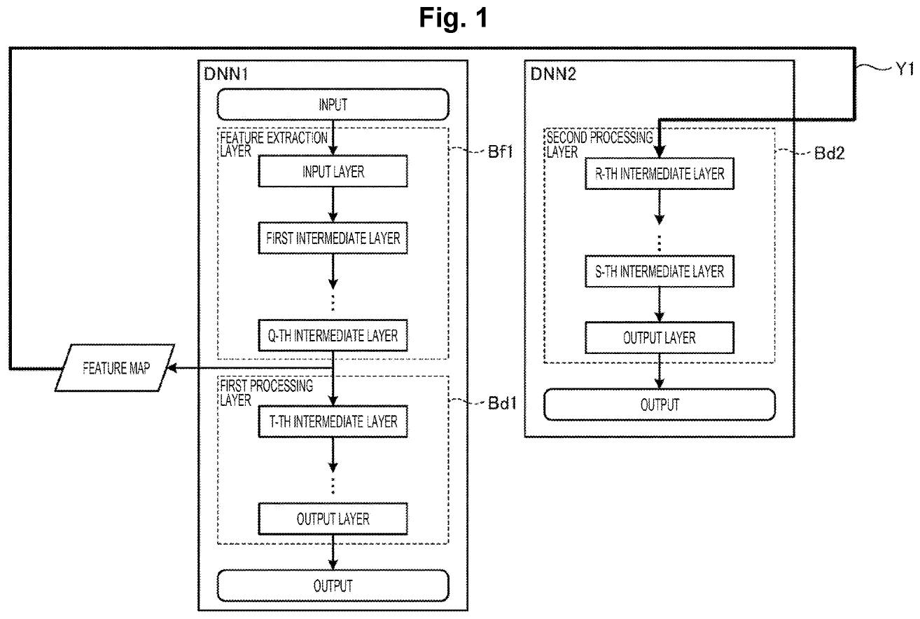

Next, the DNN 1 and the DNN 2 will be described. FIG. 1 is a diagram illustrating an example of the DNN 1 and the DNN 2. A DNN generally includes an input layer into which data is input, a plurality of intermediate layers that extract a feature amount from data input from the input layer, and an output layer that outputs a so-called inferred result such as a probability and a likelihood. An output value output from each layer may be irreversible when data to be input is required to remain anonymous.

In the processing system, the DNN 1 is used on the edge device side, and the DNN 2 is used on the server device side. The DNN 1 is a lightweight model. In the DNN 1, an output of the predetermined intermediate layer is used as a feature map. As a temporary name, the above-described intermediate layer is referred to as a feature extraction layer Bf1. The predetermined intermediate layer is selected, for example, as described in a model selection example to be described below. A layer a rear stage subsequent to the feature extraction layer Bf1 is set as a first processing layer Bd1. The first processing layer Bd1 executes an inference process related to the first task using the feature map output by the feature extraction layer Bf1.

The DNN 2 is a non-lightweight model that has a second processing layer Bd2. The second processing layer Bd2 uses the intermediate output value of the DNN 1, specifically, the feature map output from the feature extraction layer Bf1 of the DNN 1 as an input (arrow Y1), and executes inference related to the second task. In the processing system, multi-task learning is executed in advance between the DNN 1 and the DNN 2 by using learning data related to the first task and learning data related to the second task.

As described above, in the processing system according to the embodiment, the same feature map is shared between the edge device and the server device, and inference of different tasks is executed on each of the edge device side and the server device side.

As a result, when inference is executed on the server device side, execution of the feature extraction process can be omitted. Therefore, a calculation time can be shortened and delay can be reduced. Since the data output from the edge device side to the server device side is not inference target data but the feature map extracted from the inference target data, the data transmission amount from the edge device side to the server device side can be reduced.

### [Processing System]

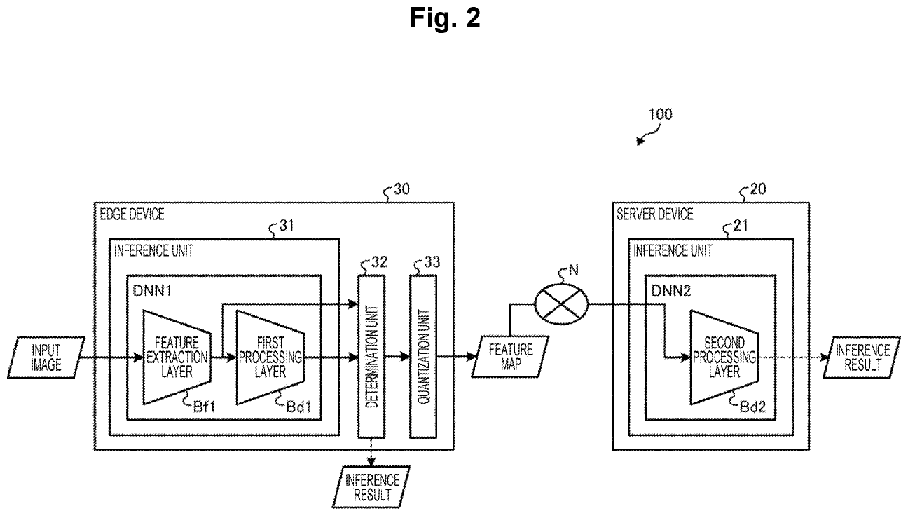

FIG. 2 is a diagram schematically illustrating an example of a configuration of the processing system according to the embodiment. The processing system 100 according to the embodiment adaptively executes an inference process in the edge device 30 using the DNN 1 and the server device 20 using the DNN 2.

The server device 20 is a device arranged at a logically distant place when compared with the edge device 30. The edge device 30 is an IoT device and any of various terminal devices arranged at a place physically and logically close to a user, and has resources fewer than the server device 20. The server device 20 and the edge device 30 are connected via a network N. The network N is, for example, the Internet.

The DNN 1 of the edge device 30 is a high-speed lightweight model and executes inference related to the first task on inference target data (in the example of FIG. 1, an image). The DNN 2 of the server device 20 is a low-speed non-lightweight model and executes inference related to the second task different from the first task. The DNN 1 and the DNN 2 are included in a model cascade. In the processing system 100, it is controlled which device executes a process between the edge device 30 and the server device 20 according to a preset rule.

The server device 20 and the edge device 30 are implemented by causing a computer or the like including a read-only memory (ROM), a random access memory (RAM), and a central processing unit (CPU) to read a predetermined program, and causing the CPU to execute the predetermined program. A so-called accelerator represented by a GPU, a vision processing unit (VPU), a field programmable gate array (FPGA), an application specific integrated circuit (ASIC), and a dedicated artificial intelligence (AI) chip is also used. Each of the server device 20 and the edge device 30 includes a network interface card (NIC) and can execute communication with another device via an electrical communication line such as a local area network (LAN) or the Internet.

### [Edge Device]

As illustrated in FIG. 2, the edge device 30 includes an inference unit 31 (an inference unit) including the DNN 1 that is a learned lightweight model, a determination unit 32 (a transmission unit), and a quantization unit 33.

The inference unit 31 executes inference related to the first task on the inference target data by using the DNN 1 that is the learned lightweight model. The DNN 1 includes information such as a model parameter. The inference unit 31 inputs inference target data (an image in the example of FIG. 2) to the DNN 1 and acquires an inference result related to the first task. In the inference unit 31, the feature extraction layer Bf1 of the DNN 1 extracts a feature amount of the inference target data and outputs the extracted feature amount as a feature map, and the first processing layer Bd1 executes inference on the inference target data based on the feature map. For example, the inference unit 31 receives an input of an inference target image, processes the inference target image by using the DNN 1, and outputs an inference result (for example, a classification result for congestion of an object shown in an image) related to the first task.

The determination unit 32 determines whether to cause the server device 20 to execute inference related to the second task on the inference target data of the first task according to the preset rule.

For example, when the inference unit 31 classifies congestion of the subject shown in the input image, the inference unit 31 classifies whether the congestion is one of “very congested,” “congested,” “ordinary,” “slightly less congested,” and “less congested.” In this case, for example, the determination unit 32 uses a rule set to cause the server device 20 to execute inference related to the second task when the classification result of the inference unit 31 is “very congested” or “congested.” When the rule is matched, that is, when the classification result of the inference unit 31 is “very congested” or “congested,” the determination unit 32 determines that the server device 20 executes the inference related to the second task.

When the determination unit 32 determines that the server device 20 executes the inference related to the second task, the feature map which is the intermediate output value of the DNN 1 is transmitted to the server device 20 so that the server device 20 executes the inference related to the second task. In other words, when the determination unit 32 determines that the server device 20 executes the inference related to the second task, the determination unit outputs the feature map which is an output of the feature extraction layer Bf1 of the DNN 1 to the server device 20, and causes the server device 20 to execute the inference related to the second task.

When the determination unit 32 determines that the server device 20 executes the inference related to the second task, the quantization unit 33 quantizes the feature map which is an intermediate output value of the DNN 1 and outputs the quantized feature map to the server device 20. The edge device 30 may encode and then quantize the feature map output to the server device 20. The edge device 30 may omit the quantization of the feature map.

### [Server Device]

The server device 20 includes an inference unit 21 that executes inference using the DNN 2 that is a learned non-lightweight model. The DNN2 includes information such as a model parameter. The DNN 2 has the second processing layer Bd2 as described above.

The inference unit 21 executes an inference process on the input image based on the feature map of the inference target data output from the edge device 30 by using the DNN 2. The inference unit 21 decodes the quantized feature map output from the edge device 30 and accepts the decoded feature map as an input of the second processing layer Bd2 of the DNN 2. The DNN 2 executes the inference related to the second task by using the feature amount map as an input. The inference unit 21 acquires an inference result (for example, a subject detection result of the subject shown in the image) as an output of the DNN 2. In the example of FIG. 2, inference target data is an image. When the inference result is returned to the user, an inference result obtained by the inference unit 21 may be transmitted to the edge device 30 and returned from the edge device 30 to the user.

Here, the server device 20 and the edge device 30 are included in a model cascade. Therefore, the inference unit 21 does not normally execute the inference related to the second task. When it is determined that the server device 20 executes the inference process related to the second task, the inference unit 21 accepts an input of the quantized feature map and executes the inference in the second processing layer Bd2 of the DNN 2.

### [Example of Task]

The first task in the edge device 30 is, for example, a classification task that classifies congestion from inference target image data of the first task and outputs a classification result. The second task in the server device 20 is, for example, a subject detection task that executes subject detection on a subject shown in image data of an inference target of the first task and outputs a detection result. Since the second task in the server device 20 shares the feature map which is the intermediate output value with the edge device 30 side and executes the process of the second processing layer Bd2, the second task is preferably somewhat similar to the task executed by the classification network (NW) of the edge device 30. Hereinafter, a combination of the first and second tasks will be exemplified.

Specifically, the first task is a task of analyzing congestion of a store, and the second task is a task of counting the number of people when it is desired to know how many people are present when the task is classified as “congestion” in the first task.

The first task is a task of analyzing congestion of a normal store, and the second task is a task of executing person detection based on a shared feature map and executing person matching only when person tracking is desired to be executed.

The first task is a task of detecting whether a person enters a restricted area, and the second task is a task of counting how many people enter the restricted area only when it is inferred that the person enters the restricted area in the first task, or a task of detecting and tracking a target person.

The first task is a task of classifying a male and a female, and the second task is a task of executing person detection and tracking of a male when the male is classified in the first task.

Hereinafter, a case where a classification task is executed in the edge device 30 and a subject detection task is executed in the server device 20 will be described as an example. The NW of the classification task is often a base of the NW of the subject detection and has a similar configuration. Since resources are limited on the edge side, a task such as a classification task having a smaller calculation amount is more desirable. The edge device 30 transmits the feature map to the server device 20 at a timing at which it is necessary to count the number of people and execute person tracking, and the server device 20 continuously detects the subject.

### [Model Selection Example of DNN 1 and DNN 2]

In the embodiment, in order to reduce a communication amount between the edge device 30 and the server device 20 and avoid repeated calculation on the cloud side, the entire NW is designed so that the intermediate layer between the classification NW of the edge device 30 and the object detection NW of the server device 20 can be shared. Therefore, specifically, a selection example of base models of the DNN 1 and the DNN 2 will be described.

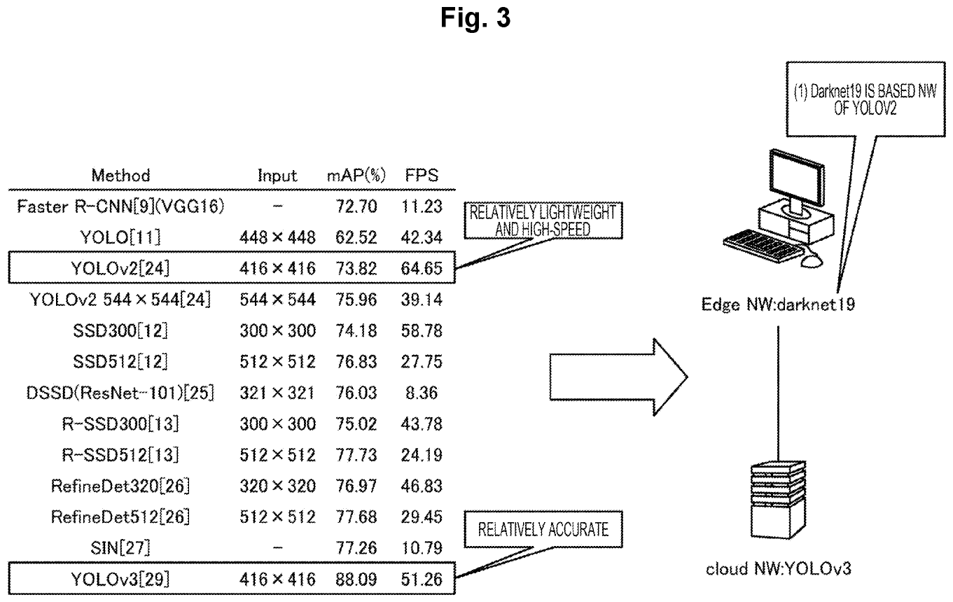

FIG. 3 is a diagram illustrating a selection example of base models of the DNN 1 and the DNN 2. In this example, as illustrated in FIG. 3, a darknet 19 ((1) in FIG. 3), which is a base NW of YOLOv2 that is relatively lightweight and high speed, is selected as a base model of the edge device 30. Then, as the subject detection model, YOLOv3 that is relatively non-lightweight was selected as the base model of the server device 20. The selected NN is exemplary and any selection may be made as long as the NN is a non-lightweight NN, a high-speed NN, and a lightweight NN, and can share the feature amount extraction layer.

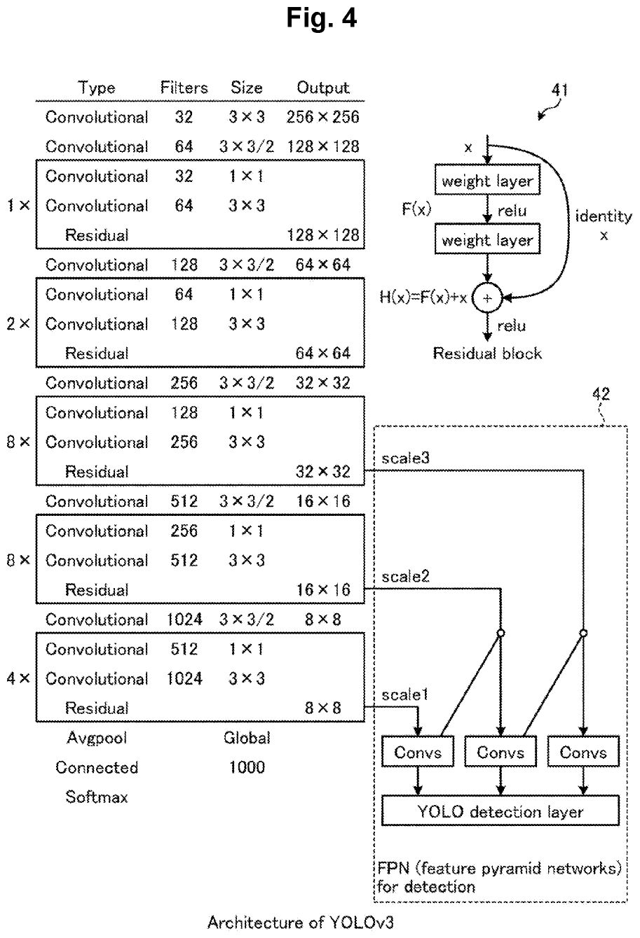

FIG. 4 is a diagram illustrating an overview of a structure of YOLOv3. YOLOv3 includes a convolution layer (a feature extraction layer) that executes feature extraction including Residual block 41 and a feature pyramid networks (FPN) 42 that is a subject detection network. Here, to share a feature map between an edge and a cloud, attention is paid to the following.

First, when the Residual block 41 is entered, accuracy is maintained in YOLOv3. Therefore, it is desirable to avoid impairing the configuration in the Residual block 41. Subsequently, in YOLOv3, it is desirable to have a configuration for receiving the feature map at a front stage of the FPN 42 so that the FPN 42 can execute subject detection using the feature map as it is. The deeper the layer is (the more the number of layers is), the heavier the calculation of the model is, and the number of parameters to be used also increases. Therefore, the DNN 1 of the edge device 30 is preferably a model that has a shallow layer to implement a lightweight and high-speed model.

### [Overview of Route]

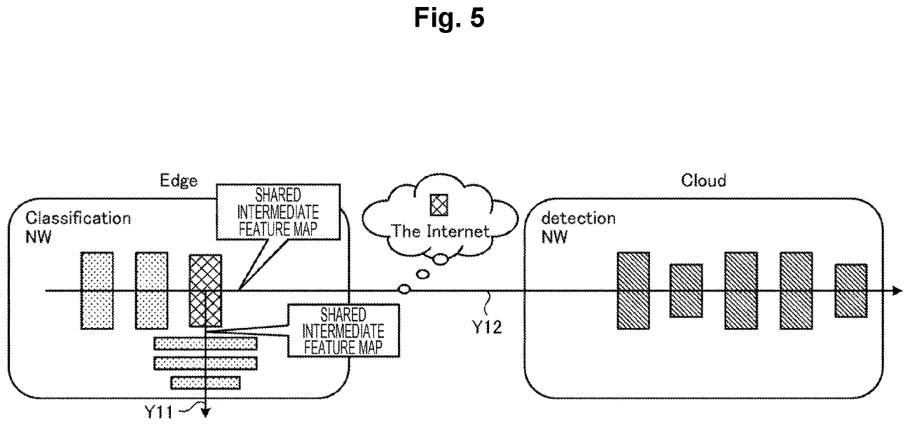

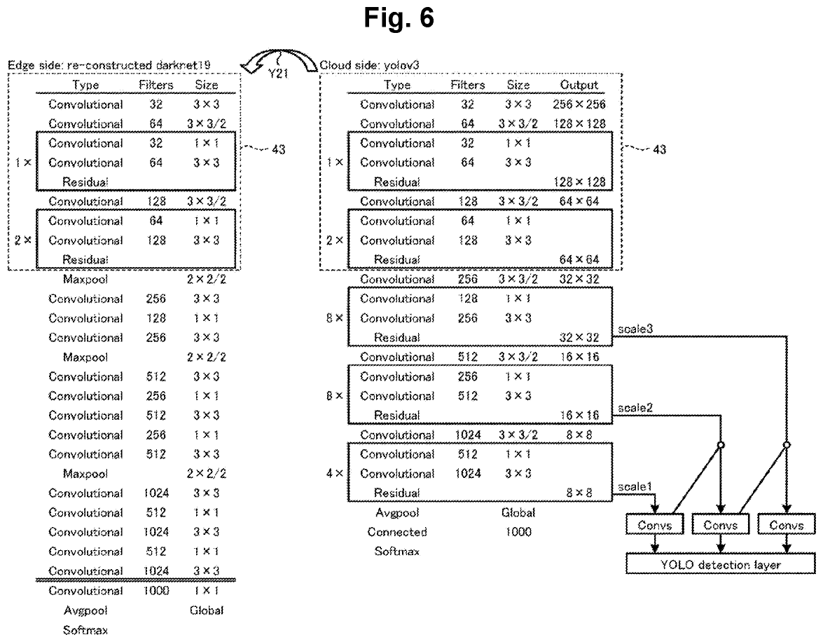

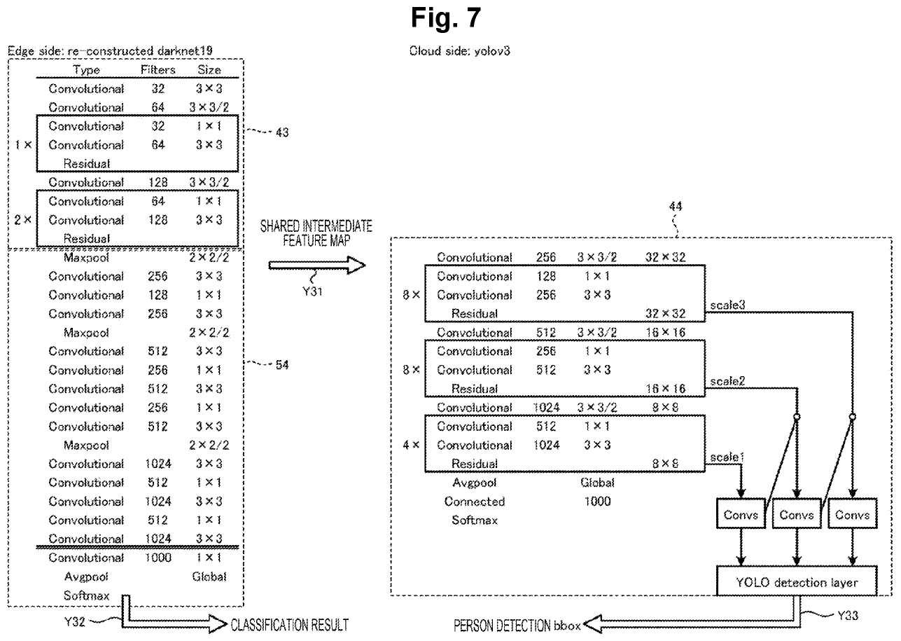

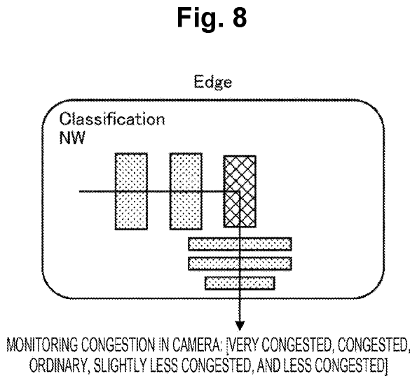

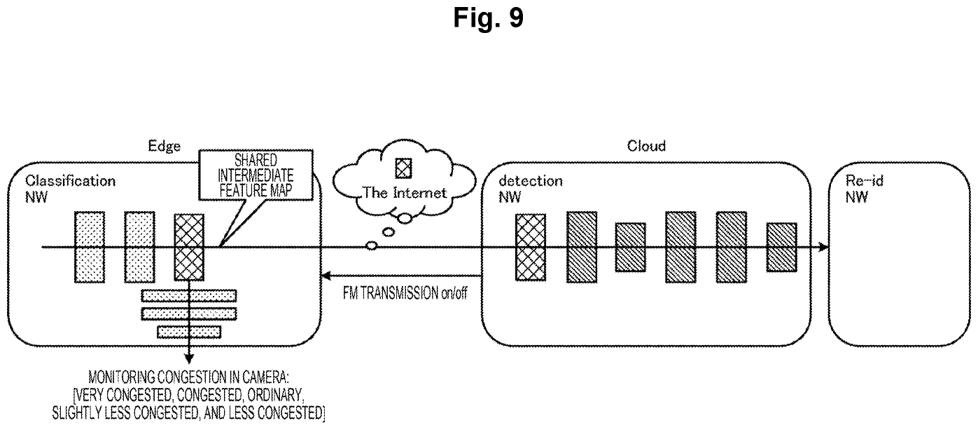

FIG. 5 is a diagram illustrating an inference route according to the embodiment. As illustrated in FIG. 5, in the edge device 30, when the feature map that is an intermediate output value shared with the server device 20 is extracted in the feature extraction layer of the classification NW, the first processing layer executes the classification task by using the feature map (an arrow Y11). Then, when the predetermined rule is matched, the feature map is transmitted from the edge device 30 to the server device 20, and the second processing layer executes the subject detection task by using the feature map (an arrow Y12). As described above, in the processing system 100, the feature map is shared and different tasks are executed on the edge side and the cloud side.

[Example of Structures of DNN 1 and DNN 2] FIGS. 6 and 7 are diagrams illustrating exemplary structures of the DNN 1 and the DNN 2. FIGS. 8 and 9 are diagrams illustrating an overview of a process of the processing system 100.

First, in the present example, as illustrated in FIG. 6, in order to avoid impairing the configuration in the Residual block 41 of YOLOv3, the feature extraction layer 43 maintaining the Residual block 41 is disposed in the front stage of the darknet 19 selected as the base model of the edge device 30 (an arrow Y 21 in FIG. 6), and the feature extraction layer 43 and the first processing layer 54 are set as the DNN 1 of the edge device 30. Then, as illustrated in FIG. 7, in the server device 20, the second processing layer 44 that has a configuration in which the feature extraction layer 43 is deleted from YOLOv3 is applied as the DNN 2.

Therefore, as illustrated in FIG. 7, in the edge device 30, the feature map is extracted from the image in the feature extraction layer 43 by using the darknet 19 re-constructed in this way, and the congestion of the subject shown in the input image is classified in the first processing layer 54 by using the extracted feature map.

Then, when the edge device 30 determines that the server device 20 does not execute the inference related to the second task according to the predetermined rule, the edge device 30 outputs the classification result of the first processing layer 54 (an arrow Y 32 in FIG. 7) and ends the process. For example, as illustrated in FIG. 8, in the normal mode, the edge device 30 monitors the congestion in the camera and outputs a classification result (for example, “very congested,” “congested,” “ordinary,” “slightly less congested,” and “less congested”) of the congestion.

Here, as described above, since the feature extraction layer 43 in the edge device 30 has a structure common to the feature extraction layer 43 of YOLOv3 which is a base model of the server device 20, the feature map output from the feature extraction layer 43 can also be shared by the second processing layer 44 of the server device 20.

When the edge device 30 determines that the server device 20 executes the inference related to the second task according to a predetermined rule, the edge device outputs the feature map which is the intermediate output value extracted by the feature extraction layer 43 to the server device 20 (an arrow Y 31 in FIG. 7). Then, the server device 20 inputs the feature map to the second processing layer 44 of YOLOv3 and outputs an inference result (for example, person detection bbox) of the second processing layer 44 (an arrow Y 33 in FIG. 7).

As illustrated in FIG. 9, for example, in the case of a criminal tracking mode, the edge device 30 and the server device 20 execute a process in conjunction with each other. Specifically, the user registers a tracking target in the server device 20 and starts tracking.

When the tracking starts, the edge device 30 receives an FM transmission-on signal from the server side, monitors the congestion, and transmits the feature map which is the shared intermediate output value to the server device 20. In the server device 20, the second processing layer 44 detects a person from the feature map and executes comparison. Then, when the tracking ends, the edge device 30 receives an FM transmission-off signal by the server device 20, disconnects the connection with the server device 20, and returns to the normal mode.

As described above, a calculation range in the server device 20 is a calculation range in the second processing layer 44. In other words, in the server device 20, calculation required for feature extraction can be omitted.

The DNN 1 and the DNN 2 are not limited to the examples of FIGS. 6 and 7 as long as the edge device 30 and the server device 20 can share the same feature map. In the feature extraction layer Bf1 of the DNN 1, and the first processing layer Bd1 of the DNN 1 and the second processing layer Bd2 of the DNN 2, the DNN 1 and the DNN 2 may be designed such that the sizes of the layers to be connected coincide with each other.

In the processing system 100, since the tasks executed by the edge device 30 and the server device 20 are different, multi-task learning is required between the DNN 1 of the edge device 30 and the DNN 2 of the server device 20. When quantization is executed, learning is executed including quantization.

For example, when the darknet 19 is selected as the base model of the edge device 30 and YOLOv3 is selected as the base model of the server device, multi-task learning may be executed using a loss function illustrated in Expression (1). λ₁ in Expression (1) is a hyperparameter indicating how important the task by the re-constructed darknet 19 is, and λ₂ is a hyperparameter indicating how much important on the task by YOLOv3 is. In Expression (1), a loss (darknet 19) is expressed by Expression (2). In Expression (1), a loss (yolov3) is expressed by Expression (3).

$$\begin{matrix}[ Math . 1 ] & \\ loss ( Multi ) = {λ}_{1} loss ( darknet 19 ) + {λ}_{2} loss ( yolov 3 ) & ( 1 )\end{matrix}$$

$$\begin{matrix}[ Math . 2 ] & \\ loss ( darknet 19 ) = CELoss or BCELoss & ( 2 )\end{matrix}$$

$$\begin{matrix}[ Math . 3 ] & \\ \begin{matrix}loss ( yolov 3 ) = {λ}_{coord} {\sum }_{i = 0}^{{S}^{2}} {\sum }_{j = 0}^{B} {{i , j}_{}}_{obj}^{} [ {( {t}_{x} - {\hat{t}}_{x} )}^{2} + {( {t}_{y} - {\hat{t}}_{y} )}^{2} \\ + {( {t}_{w} - {\hat{t}}_{w} )}^{2} + {( {t}_{h} - {\hat{t}}_{h} )}^{2} ] \\ + {\sum }_{í = 0}^{{S}^{2}} {\sum }_{j = 0}^{B} {i , j}_{obj}^{} [ - log ( σ ( {t}_{0} ) ) + {\sum }_{k = 1}^{C} BCE ( {\hat{y}}_{k} , σ ( {s}_{k} ) ) ] \\ + {λ}_{noobj} {\sum }_{i = 0}^{{S}^{2}} {\sum }_{j = 0}^{B} {i , j}_{noobj}^{} [ - log ( 1 - σ ( {t}_{0} ) ) ]\end{matrix} & ( 3 )\end{matrix}$$

### [Processing Procedure of Processing System]

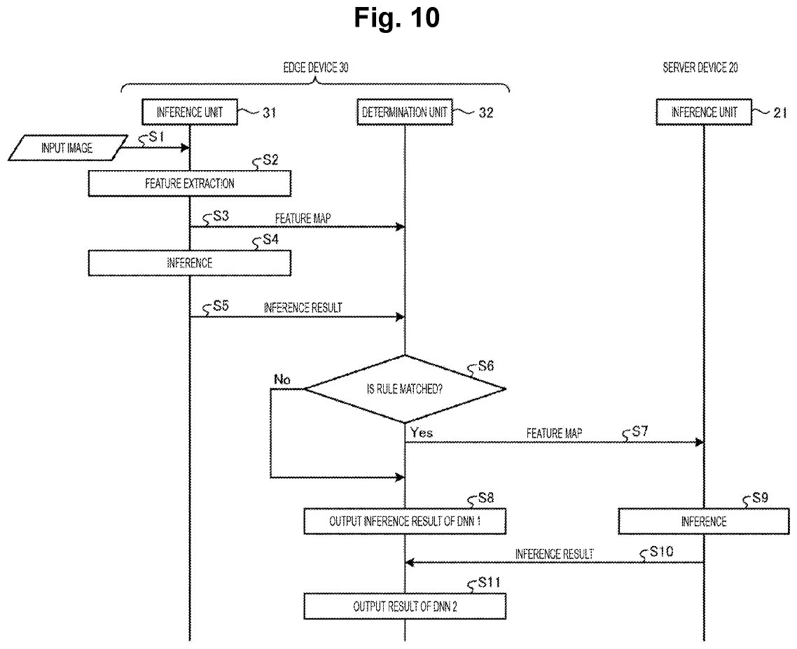

FIG. 10 is a sequence diagram illustrating a flow of a process of the processing system according to the embodiment. As illustrated in FIG. 7, first, in the edge device 30, when an input of inference target data (for example, an image) is received (step S1), the inference unit 31 inputs an input image to the DNN 1. In the DNN 1, the feature extraction layer Bf2 extracts a feature amount of the input image as a feature map (step S2) and outputs the feature amount to the determination unit 32 (step S3). In the DNN 1, the first processing layer Bd1 executes inference on the input image based on the feature map, for example, the classification process (step S4), and outputs an inference result to the determination unit 32 (step S5).

The determination unit 32 determines whether the inference result is matched to a preset rule (step S6).

When the inference result is matched to the rule (Yes in step S6), the determination unit 32 outputs the feature map to the quantization unit 33 and the quantization unit 33 transmits the quantized feature map to the server device 20 (step S7). When the inference result is not matched to the rule (No in step S6) or after step S7 ends, the determination unit 32 outputs the inference result (for example, classification results) inferred by the DNN 1 of the inference unit 31 (step S8).

In the server device 20, the inference unit 21 decodes the quantized feature map output from the edge device 30 and accepts the decoded feature map as an input of the second processing layer Bd2 of the DNN 2. The second processing layer Bd2 executes the inference process on the input image, for example, a subject detection process, based on the feature map output from the edge device 30 (step S9).

The server device 20 transmits the inference result (for example, the subject detection result) of the DNN 2 to the edge device 30 (step S10), and the inference result of the DNN 2 is output from the edge device 30 (step S11). In the embodiment, a configuration in which the inference result is returned to the user, and the final inference result is output from the edge device 30 is assumed. However, when the final inference result is used on the server device 20 side, the inference result of the DNN 2 may be output from the server device 20 or may be maintained as it is in the server device 20. When the inference result of the DNN 1 is used, the edge device 30 may transmit the inference result to the server device 20.

### [Effects of Embodiment]

As described above, in the processing system according to the embodiment, the same feature map is shared between the edge device 30 and the server device 20, and the inference of the different tasks can be executed in each of the edge device 30 side and the server device 20 side.

Accordingly, according to the embodiment, the edge device 30 executes a simpler task, and thus improvement in performance because of a reduction in a calculation amount and a reduction in latency can be expected. Then, according to the embodiment, when the inference is executed on the server device 20 side, execution of the feature extraction process can be omitted, and thus a calculation time can be shortened, and the delay can be reduced.

According to the embodiment, since the data output from the edge device 30 to the server device 20 is not the inference target data itself but the feature map extracted from the inference target data, the data transmission amount from the edge device 30 side to the server device 20 side can be reduced. According to the embodiment, when the inference target data is an image, the image itself is not transmitted to the server device 20. Therefore, privacy can be protected.

Therefore, according to the embodiment, in a case where different tasks are executed by the edge device 30 and the server device 20, it is possible to implement utilization of a calculation result executed by the edge device 30 in the server device 20 and reduction of a transmission amount between the edge device 30 and the server device 20.

In the embodiment, the feature map that is the intermediate output value of the DNN 1 can be shared even in the different tasks, and the present system configuration can be applied not only in a case where the task in the edge device 30 and the server device 20 is one task but also in a case where the tasks are different tasks, whereby a more general-purpose architecture can be proposed.

Note that, in the present embodiment, the image has been described as an example of the inference target data, but the inference target data is not limited to the image, and may be detection results detected by various sensors. Furthermore, in the present embodiment, the case where the darknet 19 and YOLOv3 are applied as the base models of the DNN 1 and the DNN 2 has been described as an example, but the base models of the DNN 1 and the DNN 2 may be appropriately set according to the task.

Furthermore, in the present embodiment, the plurality of edge devices 30 or the plurality of server devices 20 may be provided, or both the plurality of edge devices 30 and the plurality of server devices 20 may be provided.

### [System Configuration and the Like]

Each constituent of each the illustrated devices is functionally conceptual and is not necessarily physically configured as illustrated. That is, a specific form of distribution and integration of devices is not limited to the illustrated form. All or some of the constituents may be functionally or physically distributed and integrated in any unit according to various loads, use situations, and the like. Furthermore, all or some of the processing functions executed in each device can be implemented by a CPU and a program analyzed and executed by the CPU, or can be implemented as hardware by wired logic.

Of the processes described in the present embodiment, all or some of the processes described as being executed automatically can be executed manually, or all or some of the processes described as being executed manually can be executed automatically by a known method. In addition, the processing procedures, the control procedures, the specific names, and the information including various types of data and parameters illustrated in the specification and the drawings can be arbitrarily changed unless otherwise mentioned.

### [Program]

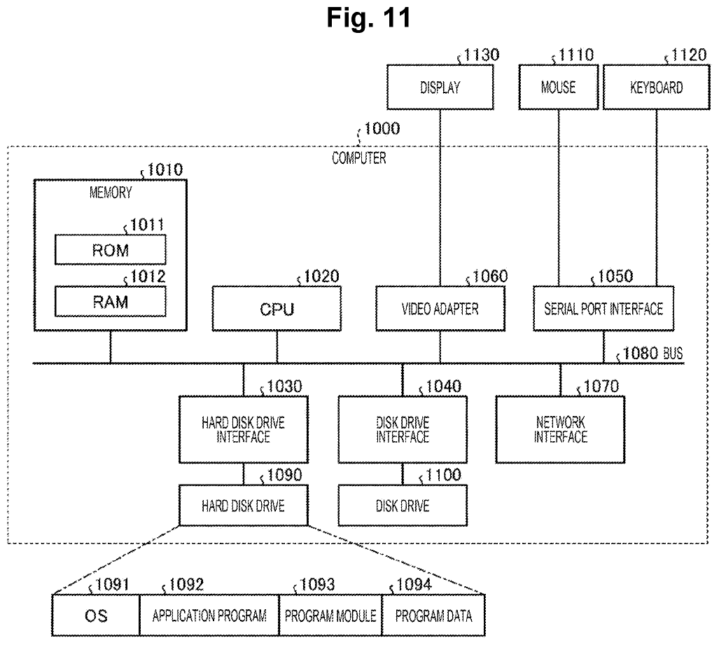

FIG. 11 is a diagram illustrating an example of a computer on which the edge device 30 and the server device 20 are implemented by executing a program. A computer 1000 includes, for example, a memory 1010 and a CPU 1020. The above-described accelerator described above may be provided to assist computation. The computer 1000 includes a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an operating system (OS) 1091, an application program 1092, a program module 1093, and program data 1094. That is, a program that defines each process of the edge device 30 and the server device 20 is implemented as the program module 1093 in which a code executable by the computer is described. The program module 1093 is stored in, for example, the hard disk drive 1090. For example, the program module 1093 executing processes similar to functional configurations of the edge device 30 and the server device 20 is stored in the hard disk drive 1090. The hard disk drive 1090 may be replaced with a solid state drive (SSD).

Setting data used in the process of the above-described embodiment is stored, for example, in the memory 1010 or the hard disk drive 1090 as the program data 1094. Then, the CPU 1020 reads and executes the program module 1093 and the program data 1094 stored in the memory 1010 or the hard disk drive 1090 to the RAM 1012, as necessary.

The program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). Then, the program module 1093 and the program data 1094 may be read by the CPU 1020 from another computer via the network interface 1070.

Although the embodiment to which the invention by the present inventor is applied has been described above, the present invention is not limited by the description and drawings which are part of the disclosure of the present invention according to the present embodiment. In other words, other embodiments, examples, operation technologies, and the like made by those skilled in the art and the like based on the present embodiment are all included in the scope of the present invention.

### REFERENCE SIGNS LIST

20 Server device
21, 31 Inference unit
30 Edge device
32 Determination unit
33 Quantization unit
100 Processing system

1. A processing method of executing an inference process, the method comprising:
executing inference according to a first task on inference target data by using a first model; and
transmitting an intermediate output value of the first model used in the executing the inference to an application configured to execute a second task, wherein the second task is distinct from the first task, and the second task has a higher operation amount than the first task.

2. The processing method according to claim 1, wherein the application is further configured to execute inference according to the second task using a second model by using the intermediate output value as an input.

3. The processing method according to claim 2,
wherein the first model includes an extraction layer extracting a feature amount which is the intermediate output value from the inference target data and a first processing layer executing the inference of the first task based on the feature amount, and
wherein the second model executes the inference of the second task by using the feature amount as an input.

4. The processing method according to claim 1,
wherein the first task includes:
classifying congestion from inference target image data of the first task, and
outputting a classification result, and
wherein the second task includes:
detecting a subject depicted in the inference target image data of the first task, and
outputting a detection result.

5. A processing system for executing an inference process, the system comprises a processor configured to execute operations comprising:
executing inference according to a first task on inference target data by using a first model; and
transmitting an intermediate output value of the first model used in the executing the inference to an application configured to execute a second task, wherein the second task is distinct from the first task, and the second task has a higher operation amount than the first task.

6. A computer-readable non-transitory recording medium storing a computer-executable program instructions that when executed by a processor cause a computer system to execute operations comprising:
executing inference according to a first task on inference target data by using a first model; and
transmitting an intermediate output value of the first model used in the executing the inference to an application configured to execute a second task, wherein the second task is distinct from the first task, and the second task has a higher operation amount than the first task.

7. The processing method according to claim 1, wherein the executing inference is performed by an edge device, the device connects to a cloud over a network, the cloud includes a server, the server is distinct from the edge device, and the server performs the second task.

8. The processing method according to claim 1, wherein the first model represents a lightweight model using a second deep neural network, and the second model represents a non-lightweight model.

9. The processing method according to claim 1,
wherein the first task includes:
determining a presence of at least a person in a restricted area based on inferencing input image data of the restricted area, and
the second task includes, when the first task detects the presence of a person, determining a number of persons in the restricted area and tracking the person as a target person.

10. The processing system according to claim 5, wherein the application is further configured to execute inference according to the second task using a second model by using the intermediate output value as an input.

11. The processing system according to claim 10,
wherein the first model includes an extraction layer extracting a feature amount which is the intermediate output value from the inference target data and a first processing layer executing the inference of the first task based on the feature amount, and
wherein the second model executes the inference of the second task by using the feature amount as an input.

12. The processing system according to claim 5,
wherein the first task includes:
classifying congestion from inference target image data of the first task, and
outputting a classification result, and
wherein the second task includes:
detecting a subject depicted in the inference target image data of the first task, and
outputting a detection result.

13. The processing system according to claim 5,
wherein the executing inference is performed by an edge device, the device connects to a cloud over a network, the cloud includes a server, the server is distinct from the edge device, and the server performs the second task.

14. The processing system according to claim 5, wherein the first model represents a lightweight model using a second deep neural network, and the second model represents a non-lightweight model.

15. The processing system according to claim 5,
wherein the first task includes:
determining a presence of at least a person in a restricted area based on inferencing input image data of the restricted area, and
the second task includes, when the first task detects the presence of a person, determining a number of persons in the restricted area and tracking the person as a target person.

16. The computer-readable non-transitory recording medium according to claim 6, wherein the application is further configured to execute inference according to the second task using a second model by using the intermediate output value as an input,
wherein the first model includes an extraction layer extracting a feature amount which is the intermediate output value from the inference target data and a first processing layer executing the inference of the first task based on the feature amount, and
wherein the second model executes the inference of the second task by using the feature amount as an input.

17. The computer-readable non-transitory recording medium according to claim 6, wherein the first task includes:
classifying congestion from inference target image data of the first task, and
outputting a classification result, and
wherein the second task includes:
detecting a subject depicted in the inference target image data of the first task, and
outputting a detection result.

18. The computer-readable non-transitory recording medium according to claim 6, wherein the executing inference is performed by an edge device, the device connects to a cloud over a network, the cloud includes a server, the server is distinct from the edge device, and the server performs the second task.

19. The computer-readable non-transitory recording medium according to claim 6, wherein the first model represents a lightweight model using a second deep neural network, and the second model represents a non-lightweight model.

20. The computer-readable non-transitory recording medium according to claim 6, wherein the first task includes:
determining a presence of at least a person in a restricted area based on inferencing input image data of the restricted area, and
the second task includes, when the first task detects the presence of a person,
determining a number of persons in the restricted area and tracking the person as a target person.
